(19) United States
(12) Patent Application Publication
(10) Pub. No.: US 2026/0040170 A1
(43) Pub. Date: Feb. 5, 2026

(54) TRANSFERRED CONTEXT NOTIFICATION IN WLANS

(71) Applicant: Samsung Electronics Co., Ltd., Suwon-si (KR)

(72) Inventors: Peshal Nayak, Plano, TX (US); Boon Loong Ng, Plano, TX (US); Bilal Sadiq, Plano, TX (US); Vishnu Vardhan Ratnam, Frisco, TX (US); Yue Qi, Plano, TX (US); Rubayet Shafin, Allen, TX (US)

(21) Appl. No.: 19/266,065

(22) Filed: Jul. 10, 2025

Related U.S. Application Data
(60) Provisional application No. 63/678,899, filed on Aug. 2, 2024.
(60) Provisional application No. 63/688,136, filed on Aug. 28, 2024.
(60) Provisional application No. 63/688,174, filed on Aug. 28, 2024.
(60) Provisional application No. 63/697,166, filed on Sep. 20, 2024.
(60) Provisional application No. 63/751,924, filed on Jan. 31, 2025.

(51) Int. Cl. H04W 36/08; H04W 8/02

(52) U.S. Cl. CPC H04W 36/08; H04W 8/02

(57) ABSTRACT

Methods and apparatuses for transferred content notification in next generation WLANs. A method of wireless communication performed by a station (STA) includes determining to roam from a first access point (AP) to a second AP. The method further includes receiving a context transfer notification associated with a context that has been set up with the first AP. The context transfer notification indicates whether the context has been transferred from the first AP to the second AP.

### CROSS-REFERENCE TO RELATED APPLICATIONS AND CLAIM OF PRIORITY

This application claims priority under 35 U.S.C. § 119(e) to U.S. Provisional Patent Application No. 63/678,899, filed on Aug. 2, 2024, U.S. Provisional Patent Application No. 63/688,136, filed on Aug. 28, 2024, U.S. Provisional Patent Application No. 63/688,174, filed on Aug. 28, 2024, U.S. Provisional Patent Application No. 63/697,166, filed on Sep. 20, 2024, and U.S. Provisional Patent Application No. 63/751,924, filed on Jan. 31, 2025, each of which are hereby incorporated by reference in its entirety.

### TECHNICAL FIELD

This disclosure relates generally to wireless communication, and more specifically to transferred content notification in Wireless Local Area Networks (WLANs) including next generation WLANs.

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for transferred content notification in WLANs.

In one embodiment, a method of wireless communication performed by a station (STA) includes determining to roam from a first access point (AP) to a second AP. The method further includes receiving a context transfer notification associated with a context that has been set up with the first AP, the context transfer notification indicating whether the context has been transferred from the first AP to the second AP.

In another embodiment, an AP comprises a transceiver, and a processor operably coupled with the processor. The processor is configured to receive, via the transceiver, an indication that a STA has determined to roam from the first AP to a second AP. The processor is further configured to transmit, via the transceiver, a context transfer notification associated with a context that has been set up with the STA, the context transfer notification indicating whether the context has been transferred from the first AP to the second AP.

In yet another embodiment, a STA comprises: a transceiver, and a processor operably coupled with the transceiver. The processor is configured to: determine to roam from a first AP to a second AP, and to receive a context transfer notification associated with a context that has been set up with the first AP, the context transfer notification indicating whether the context has been transferred from the first AP to the second AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of stages involved during a mobility handover procedure according to embodiments of the present disclosure;

FIG. 5 illustrates an example of a logical AP multi-link device (MLD) according to embodiments of the present disclosure;

FIG. 6 illustrates an example of a notification prior to roaming operation according to embodiments of the present disclosure;

FIG. 7 illustrates another example of a notification prior to roaming operation according to embodiments of the present disclosure;

FIG. 8 illustrates yet another example of a notification prior to roaming operation according to embodiments of the present disclosure;

FIG. 9 illustrates another example of a notification prior to roaming operation according to embodiments of the present disclosure;

FIG. 10 illustrates an example of a notification at the time of roaming operation according to embodiments of the present disclosure;

FIG. 11 illustrates another example of a notification at the time of roaming operation according to embodiments of the present disclosure;

FIG. 12 illustrates an example of a notification upon roaming operation according to embodiments of the present disclosure;

FIG. 13 illustrates another example of a notification upon roaming operation according to embodiments of the present disclosure;

FIG. 14 illustrates an example format for transferred content indication according to embodiments of the present disclosure;

FIG. 15 illustrates an example synchronization of media access control (MAC) and physical layer (PHY) capabilities information items according to embodiments of the present disclosure;

FIG. 16 illustrates an example roaming entity operation according to embodiments of the present disclosure;

FIG. 17 illustrates an example transfer during pre-roam setup operation according to embodiments of the present disclosure;

FIG. 18 illustrates an example transfer during roaming operation according to embodiments of the present disclosure;

FIG. 19 illustrates an example target wake time (TWT) setup transfer operation according to embodiments of the present disclosure;

FIG. 20 illustrates an example of the creation of a new TWT setup transfer according to embodiments of the present disclosure; and

FIG. 21 illustrates an example method performed by a STA in a wireless communication system according to embodiments of the present disclosure.

### DETAILED DESCRIPTION

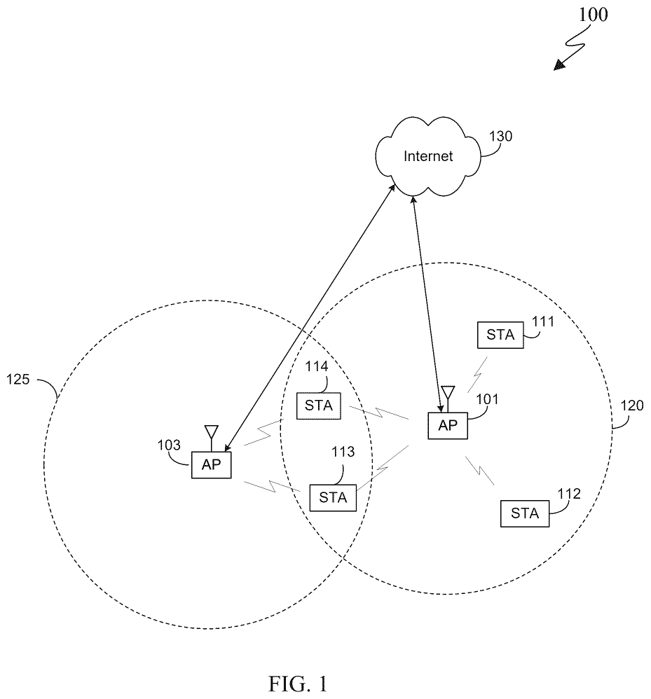

FIGS. 1 through 21, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023; [2] IEEE Std 802.11-2020; [3] IEEE P802.11be/D2.0, 2022.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating transferred content notification in next generation WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

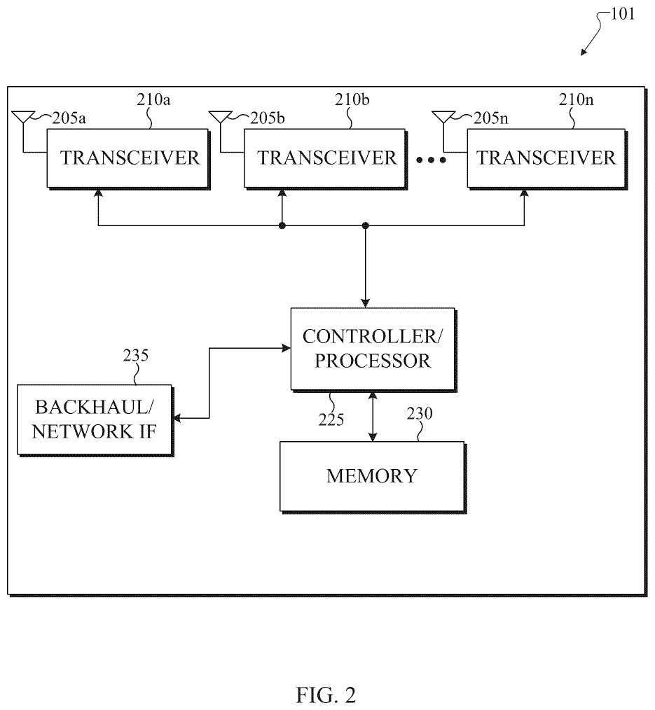

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating transferred content notification in next generation WLANs. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating transferred content notification in next generation WLANs. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in other APs. Also, various components in FIG. 2 could be combined, further subdivided, or omitted and additional components could be added according to particular needs.

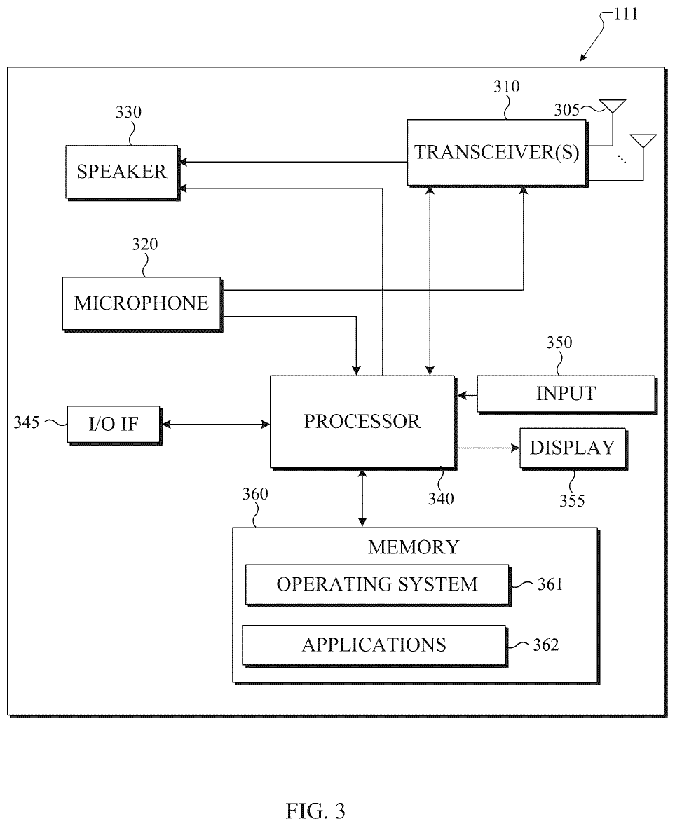

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate transferred content notification in next generation WLANs. In some embodiments, the processor 340 includes at least one microprocessor or microcontroller.

The processor 340 is also capable of executing other processes and programs resident in the memory 360, such as operations for facilitating transferred content notification in next generation WLANs. The processor 340 can move data into or out of the memory 360 as required by an executing process. In some embodiments, the processor 340 is configured to execute a plurality of applications 362, such as applications for facilitating transferred content notification in next generation WLANs. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that as users move around, the signal strength of a station (STA) to its connected access point (AP) can vary. If user movement causes a significant decrease in the signal strength, a handover is necessary. During the process of handover, the STA switches from its current associated AP to a new AP.

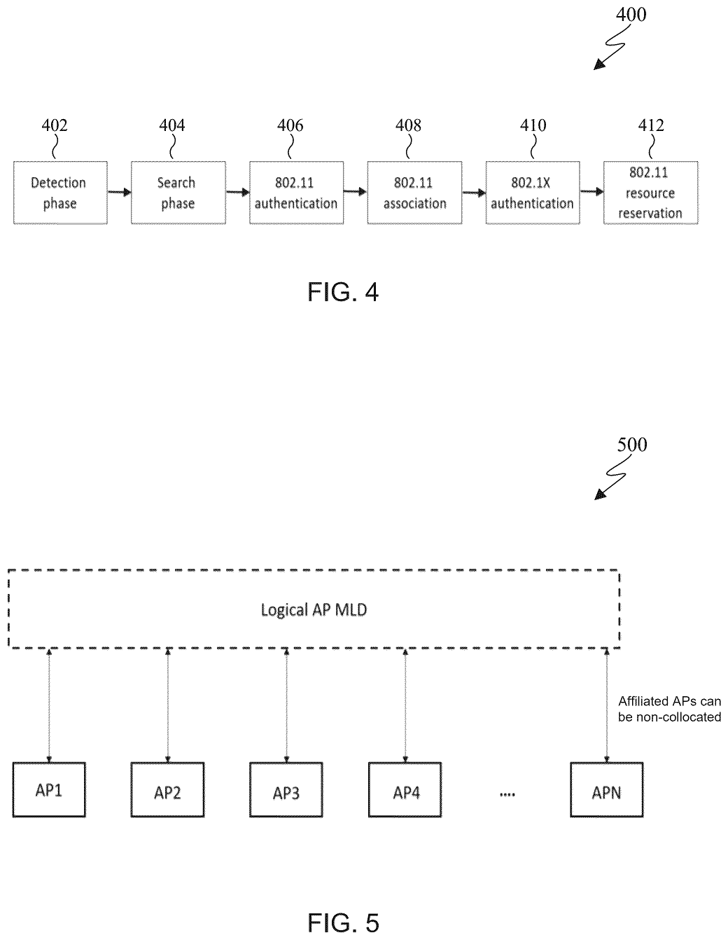

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in devices without any mobility support, the handover procedure involves the following steps:

1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.

2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.

3. 802.11 authentication: after the scanning procedure is complete, the next step is to perform 802.11 authentication 406 (open system/shared key based), where the STA establishes its identity with the AP.

4. 802.11 association: Once the STA is authenticated, the next step is to perform association 408.

5. 802.1X authentication: Introduced in IEEE 802.1i amendment, the 802.1X authentication phase 410 comprises an EAP authentication between the STA and a AAA server with the assistance of the AP.

6. 802.11 resource reservation: Finally, in the 802.11 resource reservation phase 812, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step 406 (step 3 above) during the handover. In 2011, IEEE 802.11k introduced assisted roaming which reduces the search phase 404 (step 2 above) by allowing the STA to request the AP to send channel information of candidate neighbor APs. In 2011, IEEE 802.11v also introduced network assisted roaming to assist the search phase 404. Thus, with a combination of IEEE 802.11v and IEEE 802.11k support, the search time can be reduced by enabling the device to scan only those channels on which APs in the vicinity operate. In IEEE 802.11be, the fast BSS transition procedure was extended to cover the case of MLO operation. This procedure helps to reduce the delays encountered due to 802.11 resource reservation 412 (step 6 above).

FIG. 5 illustrates an example of a logical AP multi-link device (MLD) 500 according to embodiments of the present disclosure. For example, the logical MLD device 500 can be made up of multiple APs, including any of the APs 101, 103 of FIG. 1. The embodiment of the logical MLD device 500 shown in FIG. 5 is for illustration only. Other embodiments of the logical MLD device 500 could be used without departing from the scope of this disclosure.

### A. Transferred Context Notification

Embodiments of the present disclosure recognize that in next generation WLANs, a target for low-latency with high reliability support can be targeted. In order to meet this goal, the concept of a logical AP MLD can be considered. As depicted in FIG. 5, a logical AP MLD can be made up of several APs which can be non-collocated. This is different from the concept of AP MLD in IEEE 802.11be which considers collocated APs affiliated with an AP MLD.

As depicted in FIG. 5, AP 1 to AP N can be non-collocated. Further, one or more of these APs can have a common data path to a router or a central controller. The APs shown in FIG. 5 can form a logical AP MLD. This new concept of AP MLD is expected to reduce the delays of association and authentication steps mentioned above as the STA may not need to perform association and authentication during handover.

In some embodiments, logical AP MLD can imply any kind of connection between physical APs to enable coordination amongst them. Example connections between physical APs can include roaming AP MLD, non-collocated AP MLD, SMD, etc.

Before a STA roams from its current AP to a target AP, the STA may have setup multiple features at the current AP (see examples in Table 1 below).

TABLE 1
Examples of contexts that may be setup with the current AP.

| Context | Type |
|---|---|
| Sequence Number (SN) | Dynamic |
| Packet Number (PN) | Dynamic |
| Block ACK (BA) parameters (e.g., SN) | Dynamic |
| Security keys (e.g., PTKs, GTKs, etc.) | Near Static |
| BA setup | Near Static |
| SCS/MSCS | Near Static |
| EPCS | Near Static |
| TWT and variants (rTWT, bTWT, individual | Near Static |
| TWT, etc.) | |
| P2P TWT/CoEx Sessions | Near Static |
| Power Save: Dynamic SMPS, UPSD, WNM, | Near Static |
| Intra PPDU PS, etc. | |
| EMLSR setup | Near Static |
| EMLMR setup | Near Static |
| PHY Capabilities | Near Static |

Thus, a context transfer may be necessary to ensure that the STA does not have to re-setup the context again at the target AP. However, the current AP may not be able to transfer all the contexts to the target AP when the STA roams. Parameters for some features such as SCS, TWT, etc. may not be accepted by the target AP and the target AP may require the STA to re-negotiate them again after roam. However, the STA needs to be aware of which contexts have been transferred and which ones need to be re-negotiated again at the target AP.

A procedure which can inform the STA about the contexts which have been transferred and the ones which need to be re-negotiated at the target AP is needed. This can also be helpful for the STA for AP selection. For example, the STA may prefer an AP that can take its preferred contexts or an AP that can take all its contexts over the ones that don't.

### B. Capabilities Information Handling

In next generation WLANs, a target for low-latency with high reliability support can be targeted. In order to meet this goal, the concept of a logical AP MLD can be considered. As depicted in FIG. 5, a logical AP MLD can be made up of several APs which can be non-collocated. This is different from the concept of AP MLD in IEEE 802.11be which considers collocated APs affiliated with an AP MLD.

When a STA associates with an AP, it provides the AP with a number of MAC and PHY capabilities information items. Some examples can be as follows-supported rates, extended supported rates, power capabilities, supported channels, QoS capabilities, supported operating classes, multi-band capabilities, DMG capabilities, multiple MAC sublayers presence information, etc. The present disclosure refers to all such information that characterize the STA's MAC and PHY capabilities as MAC and PHY capabilities information items.

These information items are exchanged as a part of frame exchanges that occur during roaming. However, with seamless roaming, all those frame exchanges can be skipped. Thus, the candidate target/target AP may not be aware of the MAC and PHY capabilities information items corresponding to a particular STA.

A procedure and behavior is needed by which the candidate target/target AP MLD can be informed about the STA's MAC and PHY capabilities information.

### C. TWT Context Transfer Procedure for Seamless Roaming

Embodiments of the present disclosure recognize that a STA can have a setup for TWT (or its variant such as bTWT, rTWT, p2p TWT, etc.) with the AP. When a STA roams from the current AP to a target AP, the STA may need to setup the TWT or its variant again with the target AP. This can take some time. It can be beneficial if the current setup of TWT or its variant can be transferred from the current AP to the target AP so the STA can start to make use of the setup upon roaming. Sometimes the target AP may not even support the same setting for TWT or its variant as was supported by the current AP. In such a situation, setting up a new TWT with the target AP prior to roam can be beneficial.

Procedures to support the above behavior can be useful for roaming in next generation WLANs.

Accordingly, embodiments of the present disclosure provide mechanisms for handling context transfer notification in next generation WLANs, including: (i) context transfer notification; (ii) notification prior to roaming; (iii) notification at the time of roaming; (iv) notification upon roaming; and (v) a multi-link reconfiguration based procedure.

Further, embodiments of the present disclosure provide mechanisms for handling the STA's MAC and PHY capabilities information item exchange, including: (i) synchronization via a roaming entity; (ii) transfer during pre-roam setup; and (iii) transfer during roaming.

Further, embodiments of the present disclosure provide mechanisms for handling TWT context transfer, including: (i) embodiments for transfer of TWT setup; (ii) creation of a new TWT setup; (iii) whether setup can be transferred or new setup can be created; (iv) advertisement of feasibility based on existing setups; and (v) capability advertisement procedures.

### A. Transferred Context Notification

### 1. Context Transfer Notification

According to some embodiments, there can be a context transfer notification that can be provided to the STA. The context transfer notification can contain at least one or more of the information items as shown in Table 2.

TABLE 2
Information items that can be present in the context transfer notification

| Information | |
|---|---|
| items | Description |
| Transferred | One or more information item(s) that can describe the contexts that have |
| contexts | been successfully transferred. For example, a bitmap in which each bit |
| | can correspond to one feature and setting the bit to 1 can indicate that the |
| | corresponding feature has been transferred. Another example can be that |
| | of an explicit field which can take a predetermined value to indicate that a |
| | particular feature has been transferred and another value to indicate that |
| | the feature has not been transferred. |
| Non-transferred | One or more information item(s) that can indicate which contexts have |
| contexts | not been transferred or whose transferred has failed. Not being transferred |
| | can be due to the current AP's own decision. For example, the current AP |
| | may be aware beforehand the that target AP does not support a particular |
| | feature. Failure to transmit can be due to rejection from the target AP to |
| | setup the feature for the STA with the same parameters as accepted by the |
| | current AP. For example, the current AP may have agreed to a SCS setup |
| | with a QoS characteristic IE indicating a delay bound of 40 ms and the |
| | target AP may not find that acceptable and can therefore reject the |
| | transfer. |
| Reason | One or more information item(s) that can indicate the reason for the |
| information | failure to transfer one or more contexts. For example, a reason code |
| Status | One or more information item(s) that can indicate the status of the |
| information | contexts. For example, status code indicating success/failure. |
| Target AP | One or more information item(s) that can indicate which target AP the |
| identifier | above information can correspond to. For example, target AP's BSSID. |
| Deadline(s) | One or more information item(s) that can indicate the deadline until |
| | which the target/candidate target AP(s) are committed to the accepted |
| | contexts. If the STA does not roam to one of them prior to their specified |
| | deadline, then the AP may not stay committed to its accepted contexts and |
| | STA may need to re-setup after roam if it roams after the deadline. There |
| | can be one deadline for each of the target/candidate target AP(s) or a |
| | single deadline for all the APs. There can also be a deadline for each |
| | context. Alternatively, there can be a deadline for each context per AP. |

STA side behavior;

The STA can either request for the notification from the AP explicitly (e.g., via a request procedure) or implicitly (e.g., performing a preparation procedure can be an indication that the STA would like the current AP to transfer the context and inform the STA about it).

If the target/candidate target AP(s) accept all the contexts as setup with the current AP, the STA does not need to re-setup those contexts again with the target AP upon roam. Re-negotiation/updates can still be performed.

If the target/candidate target AP(s) do not accept one or more of the contexts as setup with the current AP, the STA needs to re-setup the corresponding rejected contexts again with the target AP upon roam. The STA can also use this as a criteria for AP selection. For example, select an AP that can accept all the contexts as setup with the current AP. In another example, the STA may have some preferred contexts such as SCS, rTWT, etc. as it is running a low latency application which has low throughput but stringent latency requirement. The STA may prefer an AP that accepts the corresponding contexts even if its RSSI to that AP is lower compared to another AP that rejects those contexts.

### Current AP and Target/Candidate Target AP(s) Behavior:

During one or more of the roaming procedures, the current AP can coordinate with and inform the target/candidate target AP(s) about the context that can be transferred to them. The target/candidate target AP(s) can process and determine if they can accept the corresponding parameters. If they can accept, they can inform the current AP about which parameters they can accept and/or which ones they cannot accept. The current AP can generate a notification for the STA based on the response and inform the STA about the target/candidate target AP(s)'s decision.

### 2. Notification Prior to Roaming

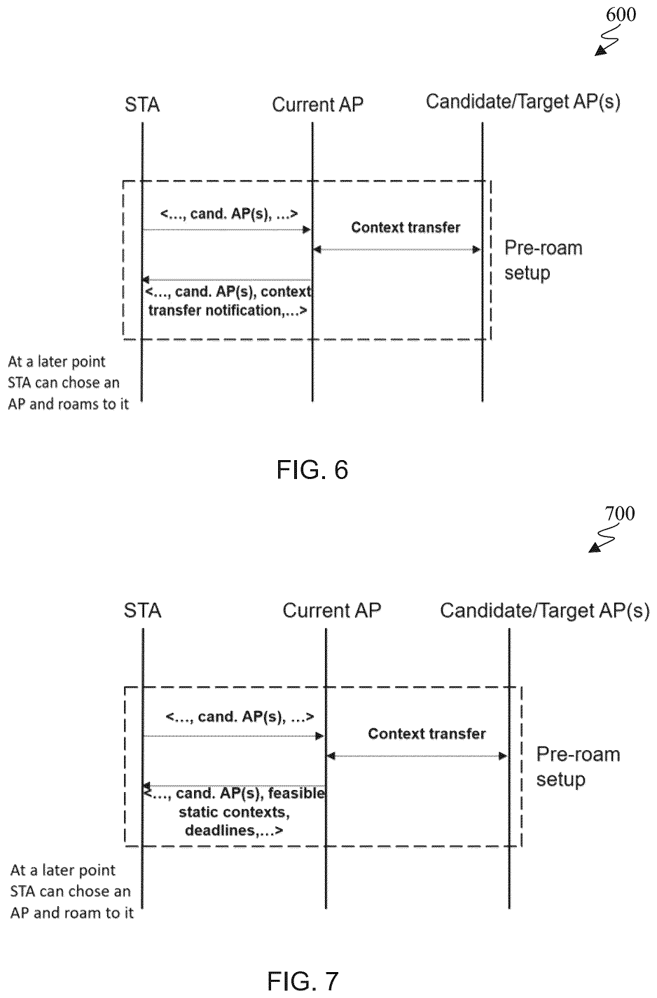

FIG. 6 illustrates an example of a notification prior to roaming operation 600 according to embodiments of the present disclosure. The notification prior to roaming operation 600 of FIG. 6 can be performed by any of the STAs 111-114 of FIG. 1, such as the STA 111 of FIG. 3, and any of the APs 101, 103 of FIG. 1. The embodiment of the notification prior to roaming operation 600 shown in FIG. 6 is for illustration only. Other embodiments of the notification prior to roaming operation 600 could be used without departing from the scope of this disclosure.

FIG. 7 illustrates another example of a notification prior to roaming operation 700 according to embodiments of the present disclosure. The notification prior to roaming operation 700 of FIG. 7 can be performed by any of the STAs 111-114 of FIG. 1, such as the STA 111 of FIG. 3, and any of the APs 101, 103 of FIG. 1. The embodiment of the notification prior to roaming operation 700 shown in FIG. 7 is for illustration only. Other embodiments of the notification prior to roaming operation 700 could be used without departing from the scope of this disclosure.

According to some embodiments, as illustrated in FIGS. 6 and 7, the context transfer notification can be sent to the STA prior to roaming. In one example, as illustrated in FIG. 6, if there is a pre-roam setup/preparation phase where the current AP attempts context transfer to one or more target/candidate target AP(s), then the current AP can provide a context transfer notification to the STA during this phase. The STA may use this information for AP selection prior to roam.

According to some embodiments, in one example, as illustrated in FIG. 7, if there is a pre-roam setup/preparation phase where the current AP attempts context transfer to one or more target/candidate target AP(s), then the context transferred prior to roam can be one or more of the near static contexts.

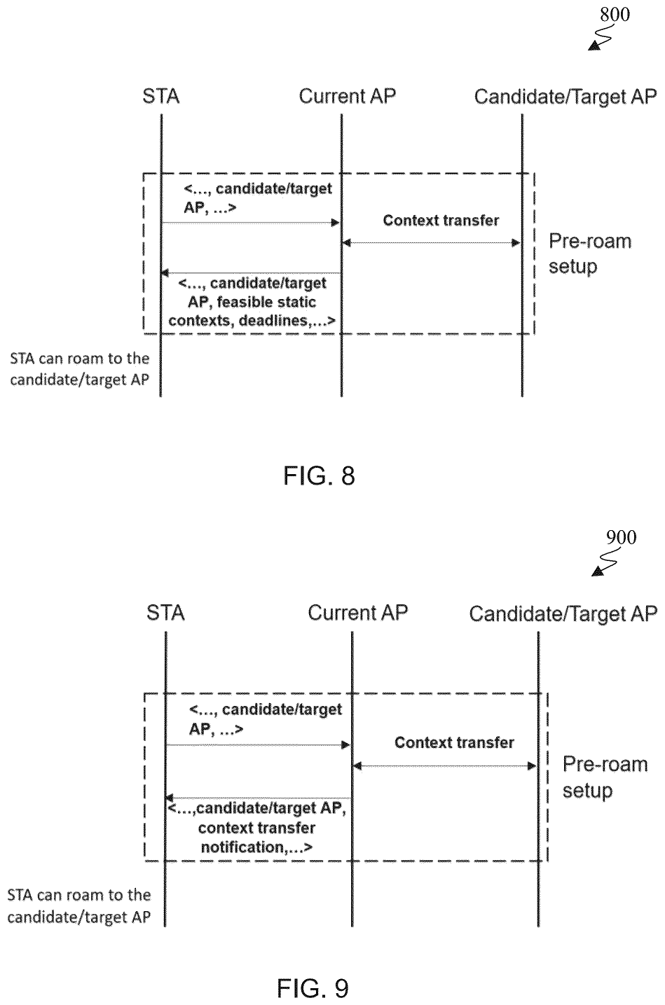

FIG. 8 illustrates yet another example of a notification prior to roaming operation 800 according to embodiments of the present disclosure. The notification prior to roaming operation 800 of FIG. 8 can be performed by any of the STAs 111-114 of FIG. 1, such as the STA 111 of FIG. 3, and any of the APs 101, 103 of FIG. 1. The embodiment of the notification prior to roaming operation 800 shown in FIG. 8 is for illustration only. Other embodiments of the notification prior to roaming operation 800 could be used without departing from the scope of this disclosure.

FIG. 9 illustrates another example of a notification prior to roaming operation 900 according to embodiments of the present disclosure. The notification prior to roaming operation 900 of FIG. 9 can be performed by any of the STAs 111-114 of FIG. 1, such as the STA 111 of FIG. 3, and any of the APs 101, 103 of FIG. 1. The embodiment of the notification prior to roaming operation 900 shown in FIG. 9 is for illustration only. Other embodiments of the notification prior to roaming operation 900 could be used without departing from the scope of this disclosure.

According to some embodiments, as illustrated in FIGS. 8 and 9, the context transfer notification can be sent to the STA prior to roaming. In one example, as illustrated in FIG. 8, if there is a pre-roam setup/preparation phase where the current AP attempts context transfer to one or more target/candidate target AP(s), then the context transferred prior to roam can be one or more of the near static contexts, and the STA can roam to the candidate/target AP.

In one example, as illustrated in FIG. 9, if there is a pre-roam setup/preparation phase where the current AP attempts context transfer to one or more target/candidate target AP(s), then then the current AP can provide a context transfer notification to the STA during this phase, and the STA can roam to the candidate/target AP.

### 3. Notification at the Time of Roaming

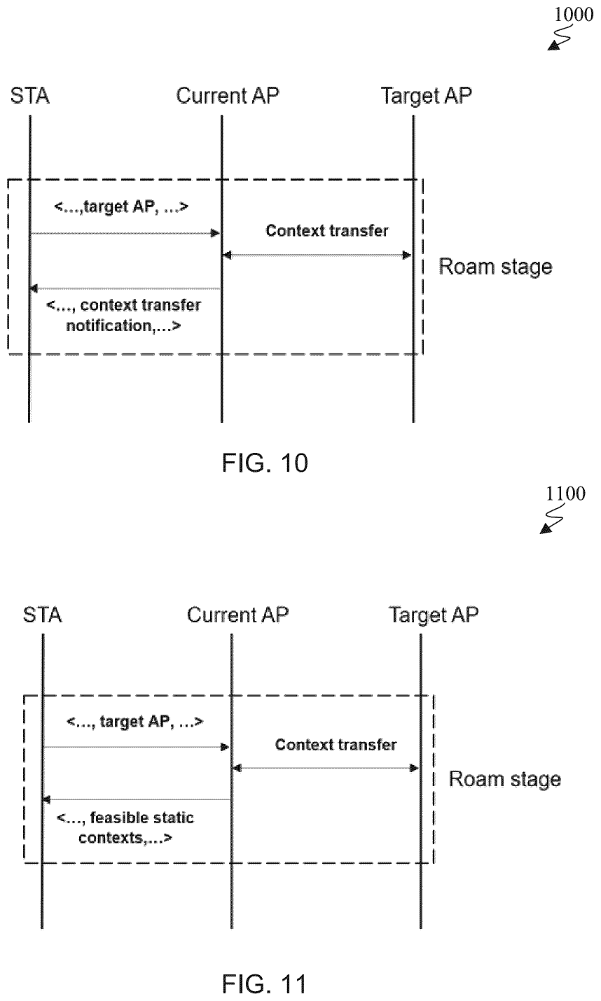

FIG. 10 illustrates an example of notification at the time of roaming 1000 according to embodiments of the present disclosure. The notification at the time of roaming 1000 of FIG. 10 can be performed by any of the STAs 111-114 of FIG. 1, such as the STA 111 of FIG. 3, and any of the APs 101, 103 of FIG. 1. The embodiment of the notification at the time of roaming 1000 shown in FIG. 10 is for illustration only. Other embodiments of the notification at the time of roaming 1000 could be used without departing from the scope of this disclosure.

FIG. 11 illustrates another example of notification at the time of roaming operation 1100 according to embodiments of the present disclosure. The notification at the time of roaming operation 1100 of FIG. 11 can be performed by any of the STAs 111-114 of FIG. 1, such as the STA 111 of FIG. 3, and any of the APs 101, 103 of FIG. 1. The embodiment of the notification at the time of roaming 1100 shown in FIG. 11 is for illustration only. Other embodiments of the notification at the time of roaming 1100 could be used without departing from the scope of this disclosure.

The context transfer notification can also be provided at the time of roaming, where the STA has already selected an AP and indicates to the current AP about its intention to roam to the AP. This can be useful for scenarios where the STA does not have time to perform a pre-roam setup or its deadline is exceeded.

According to some embodiments, as illustrated in FIGS. 10 and 11, the context transfer notification can be sent to the STA at the time of roaming. In one example, as illustrated in FIG. 10, if there is a roam stage phase where the current AP attempts context transfer to one or more target/candidate target AP(s), then the current AP can provide a context transfer notification to the STA during this phase.

In another example, as illustrated in FIG. 11, if there is a roam stage phase where the current AP attempts context transfer to one or more target/candidate target AP(s), then the context transferred at the time of roaming can be one or more of the near static contexts.

### 4. Notification Upon Roaming.

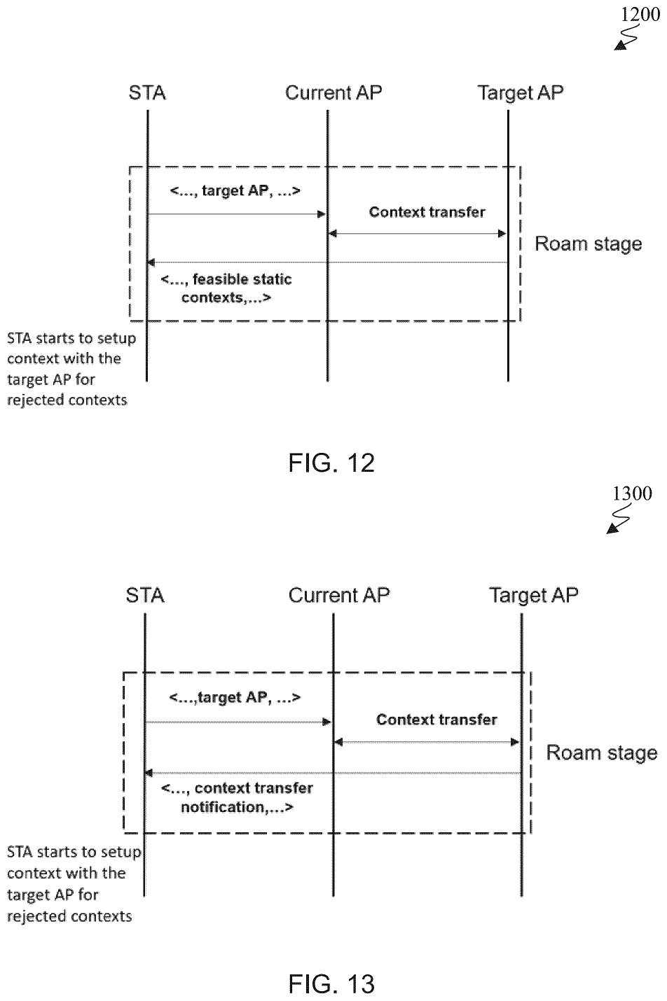

FIG. 12 illustrates an example of notification upon roaming operation 1200 according to embodiments of the present disclosure. The notification upon roaming operation 1200 of FIG. 12 can be performed by any of the STAs 111-114 of FIG. 1, such as the STA 111 of FIG. 3, and any of the APs 101, 103 of FIG. 1. The embodiment of the notification upon roaming operation 1200 shown in FIG. 12 is for illustration only. Other embodiments of the notification upon roaming 1200 could be used without departing from the scope of this disclosure.

FIG. 13 illustrates another example of notification upon roaming operation 1300 according to embodiments of the present disclosure. The notification prior to roaming operation 1300 of FIG. 13 can be performed by any of the STAs 111-114 of FIG. 1, such as the STA 111 of FIG. 3, and any of the APs 101, 103 of FIG. 1. The embodiment of the notification upon roaming 1300 shown in FIG. 13 is for illustration only. Other embodiments of the notification upon roaming 1300 could be used without departing from the scope of this disclosure.

The notification can also be provided to the STA upon roaming. This notification can be provided by the target AP. This procedure may be necessary if by the time the context transfer is completed, the STA is outside the range of the current AP and may roam to the target AP.

The current AP can detect that the STA is outside is range based on non-reception of an ACK message for its notification and inform the target AP to send the notification to the STA.

The target AP can send the notification to the STA even without the notification for precautionary purposes.

According to some embodiments, as illustrated in FIGS. 12 and 13, the context transfer notification can be sent to the STA upon roaming. In one example, as illustrated in FIG. 12, if there is a roam stage phase where the current AP attempts context transfer to one or more target/candidate target AP(s), then the context transferred upon roaming can be one or more of the near static contexts.

In another example, as illustrated in FIG. 13, if there is a roam stage phase where the current AP attempts context transfer to one or more target/candidate target AP(s), then the current AP can provide a context transfer notification to the STA during this phase.

The above procedures can be used for any type of roaming architecture for example, SMD, non-collocated AP MLD, FT based roaming, etc.

The different notifications and response can have an acknowledgement (ACK) procedure succeeding them.

### 5. Multi-Link Reconfiguration Based Procedure

According to some embodiments, context transfer can be achieved via a link reconfiguration request frame. According to this embodiment, a modified link reconfiguration response frame can carry the context transfer notification information.

The modified link reconfiguration request frame can have a format as shown in Table 3.

TABLE 3
Context transfer notification via the multi-link reconfiguration
response frame. Order can be different and additional
information items can be present

| Order | Meaning |
|---|---|
| 1 | Category |
| 2 | Protected EHT/UHR Action |
| 3 | Dialog Token |
| 4 | Transferred context |
| | indication |
| 5 | Reason code |
| 6 | Target AP MLD identifier |
| 7 | Count |
| 8 | Reconfiguration Status List |
| 9 | Group Key Data (optional) |
| 10 | OCI element (optional) |
| 11 | Basic Multi-link element |
| | (optional) |

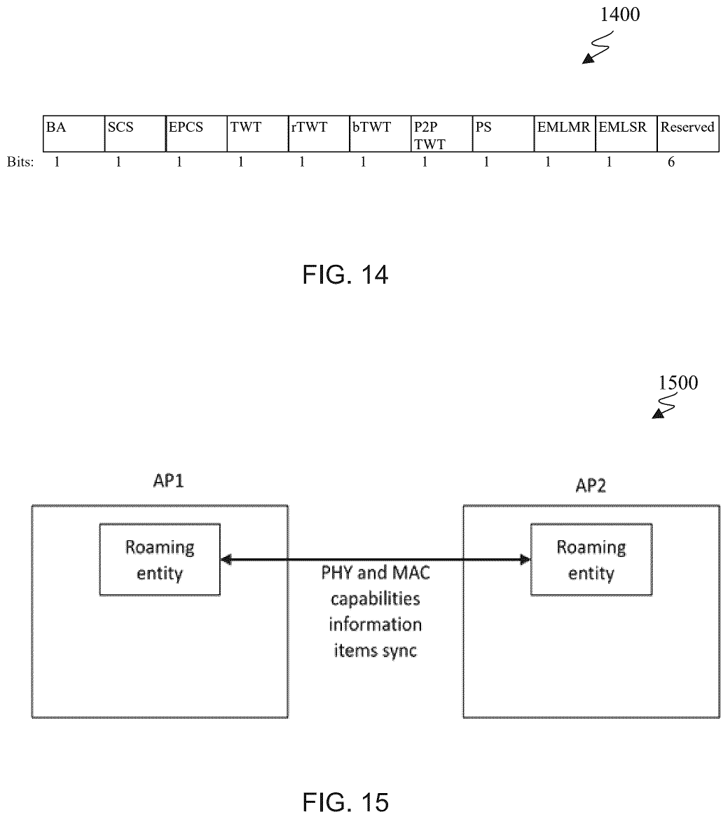

FIG. 14 illustrates an example format for transferred content indication 1400 according to embodiments of the present disclosure. The embodiment of the example format for transferred content indication 1400 shown in FIG. 14 is for illustration only. Other embodiments of the example format for transferred content indication 1400 could be used without departing from the scope of this disclosure.

As illustrated in FIG. 14, a value of 1 in the bit position corresponding to a feature can indicate to the non-AP MLD that the corresponding context has been transferred to the target AP MLD. A value of 0 in the bit position corresponding to a feature can indicate to the non-AP MLD that the corresponding context has not been transferred to the target AP MLD.

The reason code can be a list of reason codes corresponding to each feature to indicate the reason for the feature not being transferred to the target AP MLD. For example, rejection by the target AP MLD because the values were not suitable. This can also be a list of reason codes.

### B. Capabilities Information Handling

### 1. Synchronization Via a Roaming Entity

FIG. 15 illustrates an example synchronization of MAC and PHY capabilities information items 1500 according to embodiments of the present disclosure. The synchronization of MAC and PHY capabilities information items 1500 of FIG. 15 can be performed by any of the STAs 111-114 of FIG. 1, such as the STA 111 of FIG. 3, and any of the APs 101, 103 of FIG. 1. The embodiment of the example synchronization of MAC and PHY capabilities information items 1500 shown in FIG. 15 is for illustration only. Other embodiments of the example synchronization of MAC and PHY capabilities information items 1500 could be used without departing from the scope of this disclosure.

According to some embodiments, as illustrated in FIG. 15, when a STA associates with an AP that is a part of the logical AP MLD setup, a roaming entity can maintain its association information and can keep track of the MAC and PHY capabilities information items as well.

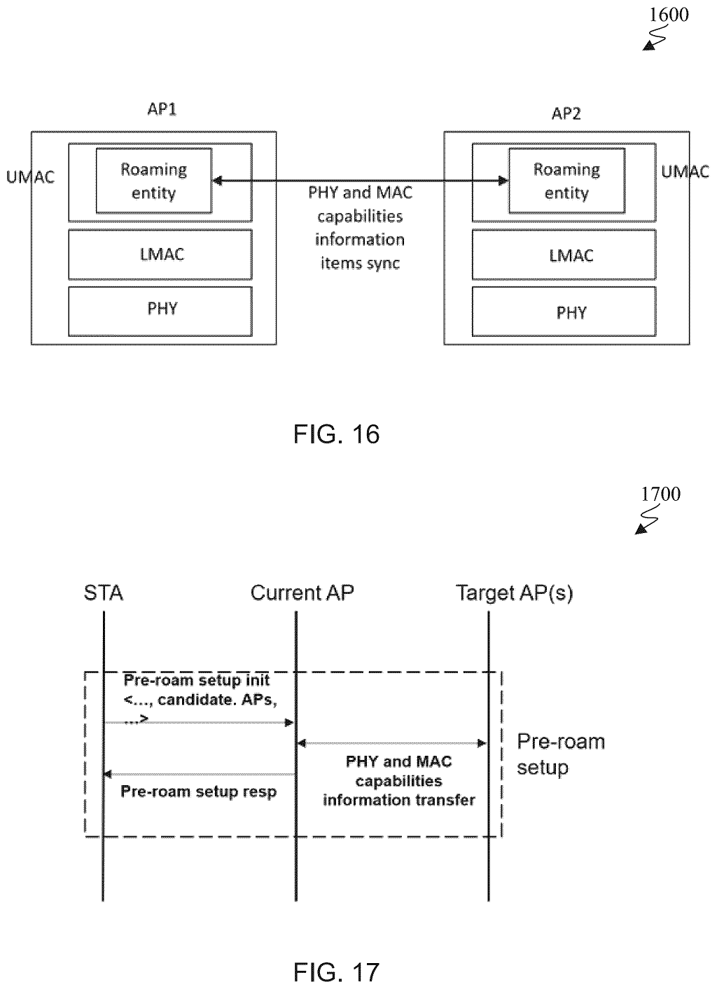

FIG. 16 illustrates an example roaming entity operation 1600 according to embodiments of the present disclosure. The roaming entity operation 1600 of FIG. 16 can be performed by any of the STAs 111-114 of FIG. 1, such as the STA 111 of FIG. 3, and any of the APs 101, 103 of FIG. 1. The embodiment of the roaming entity operation 1600 shown in FIG. 16 is for illustration only. Other embodiments of the roaming entity operation 1600 could be used without departing from the scope of this disclosure.

According to some embodiments, as illustrated in FIG. 16, this roaming entity can sync the MAC and PHY capabilities information with other APs that are a part of the roaming setup/logical AP MLD.

### 2. Transfer During Pre-Roam Setup

FIG. 17 illustrates an example transfer during pre-roam setup operation 1700 according to embodiments of the present disclosure. The transfer during pre-roam setup operation 1700 of FIG. 17 can be performed by any of the STAs 111-114 of FIG. 1, such as the STA 111 of FIG. 3, and any of the APs 101, 103 of FIG. 1. The embodiment of the transfer during pre-roam setup operation 1700 shown in FIG. 17 is for illustration only. Other embodiments of the transfer during pre-roam setup operation 1700 could be used without departing from the scope of this disclosure.

As illustrated in FIG. 17, according to some embodiments, the PHY and MAC capabilities information items can be exchanged during a pre-roam setup. The current AP can provide a status information (e.g., status code) or any form of indication that it has transferred the PHY and MAC capabilities information items to the target/candidate target AP(s) to the STA.

### 3. Transfer During Roaming

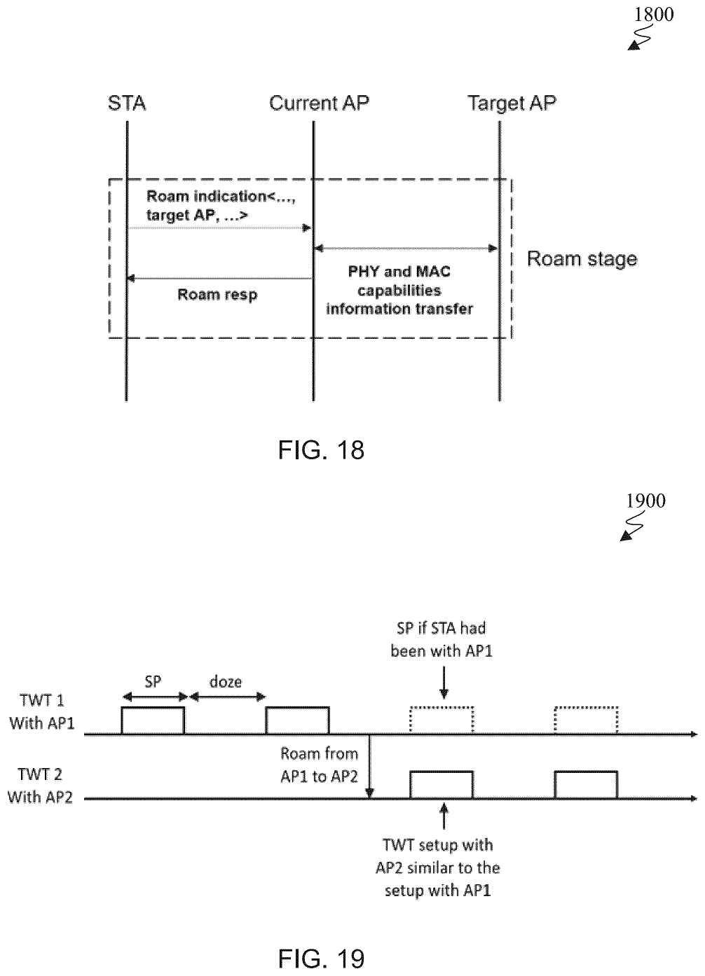

FIG. 18 illustrates an example transfer during roaming operation 1800 according to embodiments of the present disclosure. The transfer during roaming operation 1800 of FIG. 18 can be performed by any of the STAs 111-114 of FIG. 1, such as the STA 111 of FIG. 3, and any of the APs 101, 103 of FIG. 1. The embodiment of the transfer during roaming operation 1800 shown in FIG. 18 is for illustration only. Other embodiments of the transfer during roaming operation 1800 could be used without departing from the scope of this disclosure.

As illustrated in FIG. 18, according to some embodiments, the PHY and MAC capabilities information items can be exchanged during a roam stage. The current AP can provide a status information (e.g., status code) or any form of indication that it has transferred the PHY and MAC capabilities information items to the target/candidate target AP(s) to the STA.

### C.TWT Context Transfer Procedure for Seamless Roaming

In this disclosure TWT setup can refer to any kind of TWT setup, for example individual TWT, broadcast TWT, p2p TWT, rTWT, etc.

1. Transfer of TWT setup:

FIG. 19 illustrates an example TWT setup transfer operation 1900 according to embodiments of the present disclosure. The setup transfer operation 1900 of FIG. 19 can be performed by any of the STAs 111-114 of FIG. 1, such as the STA 111 of FIG. 3, and any of the APs 101, 103 of FIG. 1. The embodiment of the TWT setup transfer operation 1900 shown in FIG. 19 is for illustration only. Other embodiments of the TWT setup transfer operation 1900 could be used without departing from the scope of this disclosure.

As illustrated in FIG. 19, according to some embodiments, the TWT setup can be transferred from the current AP to the target AP. The transfer can be performed before or closer to the time when the device roams to the target AP. Transfer of TWT setup can mean having the same parameters for TWT setup at the target AP.

The STA can be informed about the new identifier of the TWT setup. For example, an ID that can be used to refer to the TWT setup.

In order to transfer the TWT setup, the APs can synchronize their TSF timers. Thus, the parameters that characterize the TWT setup can be described to the STA in reference to the TSF timer that the STA can understand.

In some embodiments, when synchronization is not possible, the STA can be given parameters that are relative to the target AP's TSF timer. The APs can coordinate amongst each other and verify that the parameters of the current and the new TWT setup are the same. The STA may not understand the parameters when associated with the current AP but upon roaming to the target AP, the STA can understand those parameters and start to make use of them.

In some embodiments, the APs can also correct for their TSF timers. For example, when synchronization is not possible or not facilitated by implementation. Thus, the TWT setup parameters can be corrected prior to informing the STA. When the STA performs a transition, either the STA can correct the parameters according to the new TSF timer of the new AP or obtain the new timing information by using the TWT ID reference.

For TWT variants that operate based on membership, the STA can be informed whether its membership has been transmitted or not along with corresponding parameters (e.g., membership identifiers if any).

The above transfer can also have a deadline until which the target AP can stay committed to the transfer. If the STA does not roam to the target AP until that point, the transfer can be cancelled and another transfer can be needed or a re-setup may need to be done upon roam.

The transfer can be done on a request response basis (e.g., the STA sends a request to transfer, the current AP processes the request and coordinates with the target AP and confirms if the transfer is successful in a response to the STA) or in an unsolicited manner (e.g., the STA triggers a roam and the current AP transfer the TWT setup to the target AP and informs the STA about the transfer's success/failure with corresponding parameters).

### 2. Creation of a New TWT Setup

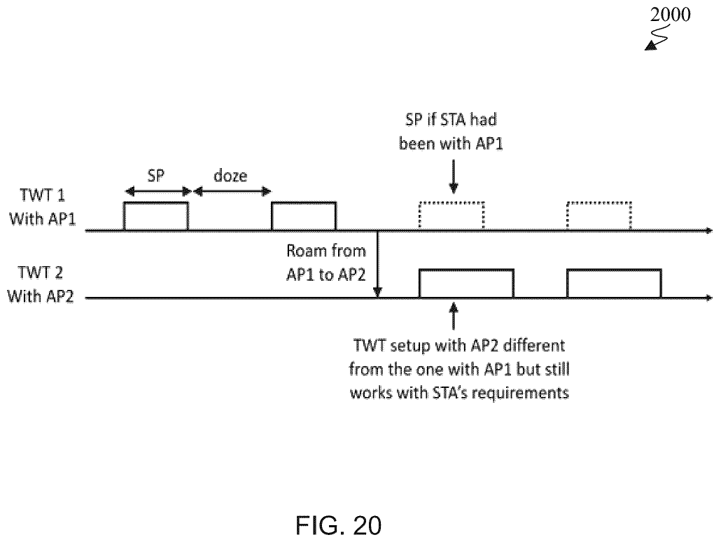

FIG. 20 illustrates an example of the creation of a new TWT setup transfer 2000 according to embodiments of the present disclosure. The embodiment of the example of the creation of a new TWT setup transfer 2000 shown in FIG. 20 is for illustration only. Other embodiments of the example of the creation of a new TWT setup transfer 2000 could be used without departing from the scope of this disclosure.

As illustrated in FIG. 20, according to some embodiments, a new TWT setup can be created at the target AP. For instance, the transfer may not be possible and the target AP can create a new TWT setup based on its knowledge of the STA's requirements, SCS setups, etc. and the STA can be informed about the new TWT setup.

For TWT setups for which the STA needs to be explicitly informed about the setup parameters (e.g., individual TWT), the STA can be provided with a TWT identifier and corresponding setup parameters such as start time, service period duration, doze period duration, etc.

These parameters can be relative to the target AP and the STA may be able to understand them upon roam when it synchronizes its TSF timer with the target AP.

For TWT variants that operate based on membership, the STA can be informed whether or not it can get membership for a schedule with the target AP that can be suitable for its requirements along with corresponding parameters (e.g., membership identifiers if any). The target AP can create a new schedule for the STA that works with the STA's requirements.

Commitment to the above creation of TWT setup can also have a deadline until which the target AP can stay committed to the creation of the schedule. If the STA does not roam to the target AP until that point, the setup can be cancelled and another request can be needed or a re-setup may need to be done upon roam.

### 3. Confirmation if Setup can be Transferred or New Setup can be Created

According to some embodiments, the current AP/target AP can confirm if the TWT setup can be transferred or not or a new one can be created with a particular AP. If the STA has more than one candidate target AP, this can enable the STA to decide which AP to roam to.

For instance, the current AP can inform the STA that its current TWT setup can be transferred or a membership to the same setup can be obtained with target AP1 but not with target AP2. In such a case, the STA can roam to target AP1 instead of target AP2.

This information can also be on a link level. For example, roaming to link 1 of target AP1 can enable a transfer and roaming to link 2 of target AP1 may not enable a transfer.

### 4. Advertisement of Feasibility Based on Existing Setups.

According to some embodiments, the AP can confirm to the STA if a TWT setup/schedule similar to its current one is feasible/available in the current AP's mobility domain or with any of the neighboring APs. This can also enable the STA to assess if it can stay in the same mobility domain when roaming or roam to another domain. The current AP can either simply provide such an indication or can provide further details such as the corresponding APs, their corresponding links, etc.

According to some embodiments, the AP can confirm to the STA if a TWT setup/schedule exists in the current AP's mobility domain or with any of its neighboring APs that meets the STA's requirements. The TWT parameters may not be the same as the STA's current TWT parameters but can meet the STA's traffic requirements.

### 5. Capability Advertisement

According to some embodiments, the AP can advertise its capability to support a TWT context transfer to the STA. This can enable the STA to invoke necessary procedures when communicating with the AP.

The STA can also advertise its capability to support necessary procedures for TWT context transfer. This can enable the AP to understand if it can invoke such procedures for the STA.

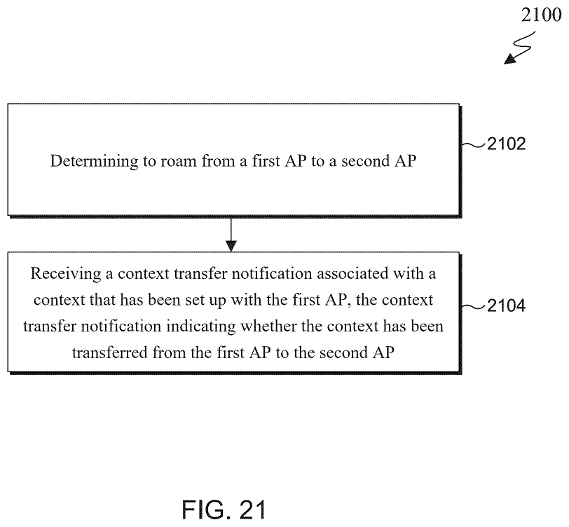

FIG. 21 illustrates an example method 2100 performed by a STA in a wireless communication system according to embodiments of the present disclosure. The method 2100 of FIG. 21 can be performed by any of the STAs 111-114 of FIG. 1, such as the STA 111 of FIG. 3. The method 2100 is for illustration only and other embodiments can be used without departing from the scope of the present disclosure.

As illustrated in FIG. 21, the method 2100 begins at step 2102, where the STA determines to roam from a first AP to a second AP. At step 2104, the STA receives a context transfer notification associated with a context that has been set up with the first AP, the context transfer notification indicating whether the context has been transferred from the first AP to the second AP.

In some embodiments, when the context transfer notification indicates that the context has been transferred from the first AP to the second AP, not negotiating setup of the context with the second AP upon roaming; and when the context transfer notification indicates that the context has not been transferred from the first AP to the second AP, negotiating setup of the context with the second AP upon roaming.

In some embodiments, the STA receives the context transfer notification from the first AP prior to roaming.

In some embodiments, the STA selects the second AP; and receives the context transfer notification from the first AP at time of roaming to the second AP.

In some embodiments, the STA receives the context transfer notification from the second AP upon roaming.

In some embodiments, the STA receives the context transfer notification via a link reconfiguration frame.

In some embodiments, the context transfer notification includes a transferred context indicator that indicates whether the context has been transferred from the first AP to the second AP.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a station (STA), the method comprising:
determining to roam from a first access point (AP) to a second AP; and
receiving a context transfer notification associated with a context that has been set up with the first AP, the context transfer notification indicating whether the context has been transferred from the first AP to the second AP.

2. The method of claim 1, wherein:
when the context transfer notification indicates that the context has been transferred from the first AP to the second AP, not negotiating setup of the context with the second AP upon roaming; and
when the context transfer notification indicates that the context has not been transferred from the first AP to the second AP, negotiating setup of the context with the second AP upon roaming.

3. The method of claim 1, further comprising:
receiving the context transfer notification from the first AP prior to roaming.

4. The method of claim 1, further comprising:
selecting the second AP; and
receiving the context transfer notification from the first AP at time of roaming to the second AP.

5. The method of claim 1, further comprising:
receiving the context transfer notification from the second AP upon roaming.

6. The method of claim 1, further comprising:
receiving the context transfer notification via a link reconfiguration frame.

7. The method of claim 1, wherein the context transfer notification includes a transferred context indicator that indicates whether the context has been transferred from the first AP to the second AP.

8. A first access point (AP) comprising:
a transceiver; and
a processor operably coupled with the transceiver, the processor configured to:
receive, via the transceiver, an indication that a station (STA) has determined to roam from the first AP to a second AP; and
transmit, via the transceiver, a context transfer notification associated with a context that has been set up with the STA, the context transfer notification indicating whether the context has been transferred from the first AP to the second AP.

9. The first AP of claim 8, wherein the processor is further configured to:
transmit, via the transceiver, the context transfer notification to the STA prior to roaming.

10. The first AP of claim 8, wherein the processor is further configured to:
transmit, via the transceiver, the context transfer notification to the STA at time of roaming.

11. The first AP of claim 8, wherein the processor is further configured to:
transmit, via the transceiver, the context transfer notification to the STA via a link reconfiguration frame.

12. The first AP of claim 8, wherein the context transfer notification includes a transferred context indicator that indicates whether the context has been transferred from the first AP to the second AP.

13. The first AP of claim 8, wherein the processor is further configured to:
coordinate with the second AP about transferring the context from the first AP to the second AP.

14. A station (STA) comprising:
a transceiver; and
a processor operably coupled with the transceiver, the processor configured to:
determine to roam from a first AP to a second AP; and
receive, via the transceiver, a context transfer notification associated with a context that has been set up with the first AP, the context transfer notification indicating whether the context has been transferred from the first AP to the second AP.

15. The STA of claim 14, wherein:
when the context transfer notification indicates that the context has been transferred from the first AP to the second AP, the processor is configured to not negotiate setup of the context with the second AP upon roaming; and
when the context transfer notification indicates that the context has not been transferred from the first AP to the second AP, the processor is configured to negotiate setup of the context with the second AP upon roaming.

16. The STA of claim 14, wherein the processor is further configured to:
receive the context transfer notification from the first AP prior to roaming.

17. The STA of claim 14, wherein the processor is further configured to:
select the second AP; and
receive the context transfer notification from the first AP at time of roaming to the second AP.

18. The STA of claim 14, wherein the processor is further configured to:
receive the context transfer notification from the second AP upon roaming.

19. The STA of claim 14, wherein the processor is further configured to:
receive the context transfer notification via a link reconfiguration frame.

20. The STA of claim 14, wherein the context transfer notification includes a transferred context indicator that indicates whether the context has been transferred from the first AP to the second AP.
